(19) United States
(12) Patent Application Publication
(10) Pub. No.: US 2022/0136265 A1
(43) Pub. Date: May 5, 2022

(54) Hose Management System for Large Format 3D Printing System

(71) Applicant: Caterpillar Inc., Peoria, IL (US)

(72) Inventor: Daniel P. Sergison, East Peoria, IL (US)

(73) Assignee: Caterpillar Inc., Peoria, IL (US)

(21) Appl. No.: 17/085,685

(22) Filed: Oct. 30, 2020

(51) Int. Cl. E04G 21/04; F16L 3/00; F16L 3/16; F16L 3/26; B33Y 30/00; E04B 1/16; E04B 1/35

(52) U.S. Cl. CPC E04G 21/0445; F16L 3/003; F16L 3/16; E04B 1/3505; B33Y 30/00; E04B 1/16; F16L 3/26

(57) ABSTRACT

A hose management system for a 3D printing system having a print medium pump and a print nozzle may include a base, a vertical tower extending upward from the base, a vertical pipe rotatably coupled to the vertical tower, a boom pipe extending laterally outward from and rotating with the vertical pipe, a stick connected to the boom pipe for relative rotation about at least two perpendicular axes, and a print hose connected between the boom pipe and the print nozzle so that the vertical pipe, the boom pipe and the print hose place the print medium pump in fluid communication with the print nozzle. The print hose may be suspended from the stick such that the vertical pipe, the boom pipe, the stick and the print hose follow movement of the print nozzle by the 3D printing system to print a 3D object.

### TECHNICAL FIELD

The present disclosure relates generally to large format three dimensional (3D) printing systems and, more particularly, to a hose management system providing a flow path from a pump for print media to a printing nozzle.

### BACKGROUND

The use of 3D printing systems has been extended to larger scale projects for printing structures such as houses, walls, barracks and other substantial objects. Traditional print media such as plastics, metals and composite materials may be used in certain large format 3D printing systems. For purposes of structural integrity, traditional 3D printing media may be replaced in large format printing implementations by sturdier materials such as cement, concrete or other cementitious materials, hot asphalt or other bituminous materials, and the like. Moreover, the scale of the structures required for such 3D printing systems has increased. These systems may utilize a gantry structure to move a large format printing nozzle within a print area of the system.

The movement of the print nozzle is typically controlled in an orthogonal coordinate system having X, Y and Z axes that are perpendicular to each other. The print nozzle will potentially travel the entire length of the print area when printing a 3D object. The pump for the printing system is typically stationary and outside the print area, so sufficient hose must be provided so that the print nozzle can travel to the furthest extent of the print area. Further, to avoid creating an obstruction within the print area, the hose is carried by the gantry structure. This arrangement often results in providing a hose having a length that is at least equal to the sum of the dimensions of the print area in each of the X, Y and Z directions plus an allowance for gradual bending of the hose without collapsing and constricting flow. The length of the hose and the nature of the print medium can cause frequent clogging and the necessity of disassembling the hose from the gantry structure for cleaning.

### SUMMARY OF THE DISCLOSURE

In one aspect of the present disclosure, a hose management system for a 3D printing system having a print medium pump and a print nozzle is disclosed. The hose management system may include a base, a vertical pipe having a lower vertical pipe end and an upper vertical pipe end and operatively connected to and extending vertically upward from the base, wherein the vertical pipe is rotatable about a vertical pipe axis, and wherein a pump hose is operatively coupled to the lower vertical pipe end to place the vertical pipe in fluid communication with the print medium pump. The hose management system may further include a boom pipe having a first boom pipe end operatively connected to the upper vertical pipe end and extending laterally outward relative to the vertical pipe axis from the first boom pipe end to a second boom pipe end, wherein the boom pipe rotates with the vertical pipe about the vertical pipe axis, a stick having a first stick end operatively connected to the second boom pipe end for rotation relative to the boom pipe about at least two perpendicular axes, and a print hose having a first print hose end connected to the second boom pipe end and a second print hose end connected to the print nozzle to place the print nozzle in fluid communication with the print medium pump. The print hose may be operatively connected to the stick such that the vertical pipe, the boom pipe, the stick and the print hose follow movement of the print nozzle by the 3D printing system to print a 3D object.

In another aspect of the present disclosure, a hose management system for a 3D printing system having a print medium pump and a print nozzle is disclosed. The hose management system may include a base, a vertical tower extending upward from the base, a vertical pipe pivotally connected to the vertical tower for rotation about a vertical pipe axis and having a lower vertical pipe end and an upper vertical pipe end, and wherein a pump hose is operatively coupled to the lower vertical pipe end to place the vertical pipe in fluid communication with the print medium pump. The hose management system may further include a boom assembly operatively connected to the upper vertical pipe end and extending laterally outward relative to the vertical pipe axis from the upper vertical pipe end, wherein the boom assembly rotates with the vertical pipe about the vertical pipe axis, a stick having a first stick end operatively connected to the boom assembly for rotation relative to the boon assembly about at least two perpendicular axes, and a print hose having a first print hose end connected to the boom assembly and a second print hose end connected to the print nozzle to place the print nozzle in fluid communication with the print medium pump. The print hose may be operatively connected to the stick such that the vertical pipe, the boom assembly, the stick and the print hose follow movement of the print nozzle by the 3D printing system to print a 3D object.

In a further aspect of the present disclosure, a hose management system for a 3D printing system having a print medium pump and a print nozzle is disclosed. The hose management system may include a base, a vertical tower extending upward from the base, a vertical pipe having a lower vertical pipe end, an upper vertical pipe end and a vertical pipe axis, and wherein a pump hose is operatively coupled to the lower vertical pipe end to place the vertical pipe in fluid communication with the print medium pump. The hose management system may further include a lower swivel bearing connecting the lower vertical pipe end to the vertical tower, an upper swivel bearing connecting the upper vertical pipe end to the vertical tower, wherein the lower swivel bearing and the upper swivel bearing pivotally connect the vertical pipe to the vertical tower for rotation about the vertical pipe axis, a boom pipe operatively connected to the upper vertical end and extending laterally outward relative to the vertical pipe axis from the upper vertical pipe end, wherein the boom pipe rotates with the vertical pipe about the vertical pipe axis, and a boom extension mounted to the boom pipe opposite the vertical pipe. The hose management system may also include a stick having a first stick end and a second stick end, a stick articulation joint operatively connecting the first stick end to the boom extension for rotation of the stick relative to the boom extension about at least two perpendicular axes, and a print hose having a first print hose end connected to the boom pipe and a second print hose end connected to the print nozzle to place the print nozzle in fluid communication with the print medium pump. The print hose may be operatively connected to the stick such that the vertical pipe, the boom pipe, the stick and the print hose follow movement of the print nozzle by the 3D printing system to print a 3D object.

Additional aspects are defined by the claims of this patent.

### BRIEF DESCRIPTION OF THE DRAWINGS

FIG. 1 is an isometric view of a large format 3D printing system having a hose management system in accordance with the present disclosure;

FIG. 2 is an isometric view of the hose management system of FIG. 1;

FIG. 3 is an enlarged view of a portion of the hose management system of FIG. 1 with a vertical tower, a vertical pipe and a boom pipe partially disassembled during assembly;

FIG. 4 is an enlarged view of upper portions of the vertical tower and the vertical pipe, a portion of the boom pipe, a boom support bracket and an elbow joint of the hose management system of FIG. 1; and

FIG. 5 is an isometric view of an alternative embodiment of a hose management system in accordance with the present disclosure for the large format 3D printing system of FIG. 1.

### DETAILED DESCRIPTION

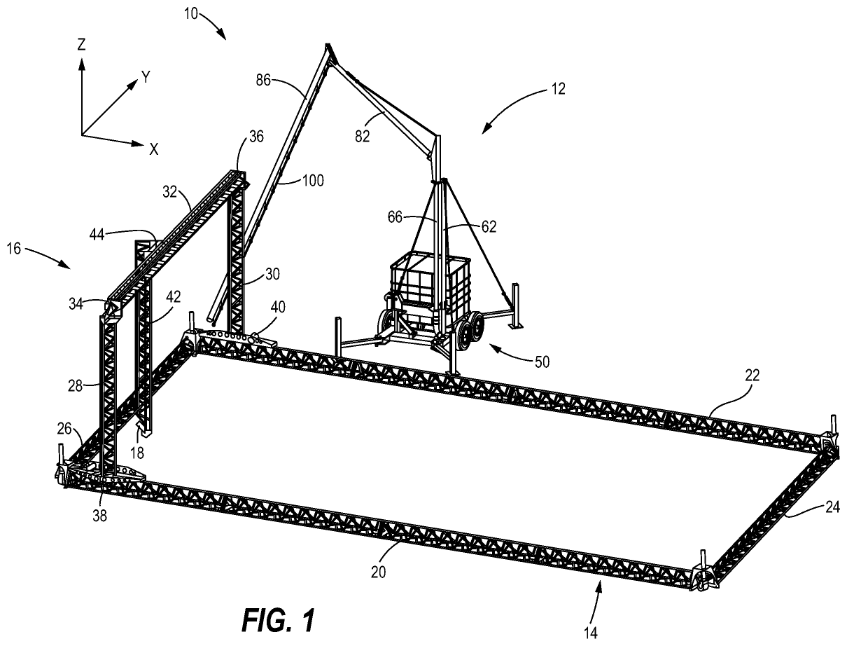

FIG. 1 illustrates an exemplary large format 3D printing system 10 in which a hose management system 12 in accordance with the present disclosure may be implemented. In addition to the hose management system 12, the large format 3D printing system 10 may include a gantry frame 14 defining a printing area of the system 10 and a gantry bridge 16 that is operable to move a print nozzle 18 according to a 3D coordinate system XYZ within the printing area to print a 3D object (not shown) using the appropriate large format print medium. The gantry frame 14 may be generally rectangular and have a pair of laterally spaced side trusses 20, 22 spaced apart and connected by a pair of end trusses 24, 26. The gantry bridge 16 may be formed by a pair of bridge upright trusses 28, 30 with a bridge cross truss 32 extending therebetween and connected thereto by a pair of corner connectors 34, 36, respectively. Each of the bridge upright trusses 28, 30 is movably mounted on a corresponding one of the side trusses 20, 22 by an X-axis carriage 38, 40. The gantry bridge 16 further includes a nozzle support truss 42 mounted to the bridge cross truss 32 by a Y-axis carriage 44. The print nozzle 18 is mounted at a bottom end of the nozzle support truss 42 so that print medium is discharged from the print nozzle 18 downward in the negative Z-direction. The print nozzle 18 may be attached so that it remains stationary relative to the nozzle support truss 42, but in alternate embodiments may be pivotally mounted to allow rotation about a vertical axis.

The elements of the gantry bridge 16 are controlled to move the print nozzle 18 within the print area defined by the gantry frame 14. The X-axis carriages 38, 40 may role, slide or otherwise move along the side trusses 20, 22 to move the gantry bridge 16 and, correspondingly, the print nozzle 18 in the X-direction. The Y-axis carriage 44 may role, slide or otherwise move along the bridge cross truss 32 to move the nozzle support truss 42 in the print nozzle 18 in the Y-direction. The large format 3D printing system 10 may include positioning mechanisms (not shown) coupled to the carriages 38, 40, 44 to move the carriages 38, 40, 44 along their respective trusses 20, 22, 32 in specified paths to print the 3D object. For example, belts, chains or cables connected to corresponding drive motors may pull the carriages 38, 40, 44 along the trusses 20, 22, 32 to direct the print nozzle 18 through the print path. Alternatively, drive motors may be mounted on each of the carriages 38, 40, 44 and operatively engage the corresponding trusses 20, 22, 32 to move the carriages 38, 40, 44 along the trusses 20, 22, 32. Further alternative drive mechanisms are contemplated. The nozzle support truss 42 may be movably coupled to the Y-axis carriage 44, and the Y-axis carriage 44 may further include a motor or other drive mechanism operatively engaging the nozzle support truss 42 to control the vertical position of the print nozzle 18 during printing of the 3D object.

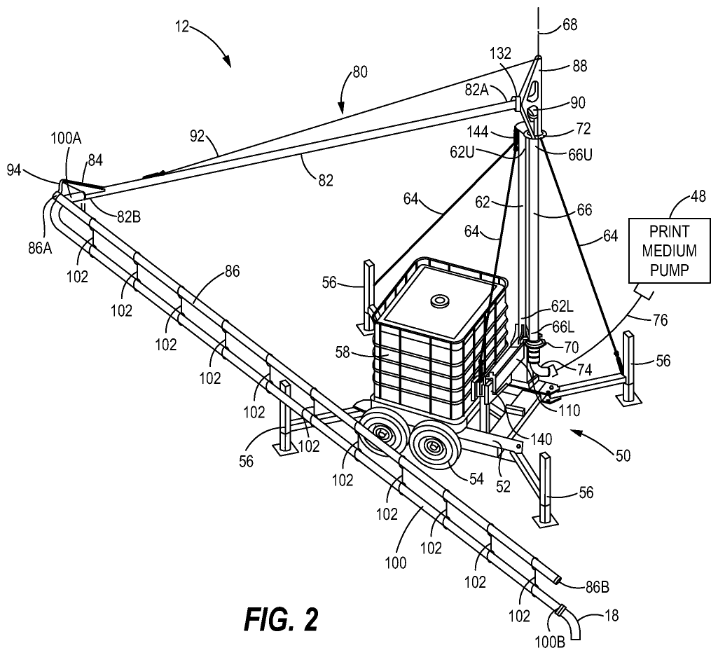

Referring to FIG. 2, the hose management system 12 in accordance with the present disclosure provides a structure for delivering print medium from a print medium pump 48 to the print nozzle 18 and following the print nozzle 18 as the gantry bridge 16 moves the print nozzle 18 through a printing path within the print area. The hose management system 12 is positioned outside the gantry frame 14 as shown in FIG. 1 to avoid interfering with the printing process. As shown in FIG. 2, the hose management system 12 is portable and includes a base 50 having a base frame 52 mounted on wheels so that the hose management system 12 may be towed or alternatively propelled by an onboard motor or engine. For stability once the base 50 is in position, a plurality of outriggers 56 are mounted to the base frame 52 and outwardly extendable to engage a work surface to level the base 50 and resist forces tending to tip over the base 50 during printing as described below. The base 50 may also include a counterweight 58 mounted on the base frame 52. As shown, the counterweight 58 as a tank or reservoir that may be filled to provide ballast when the hose management system 12 is in position for printing, and emptied after printing to facilitate transport between printing locations. In alternative embodiments, the counterweight 58 may be replaced by a print medium pump 48 mounted on the base frame 52 for ballast and being an integral component of the hose management system 12 as opposed to being a separate component of the large format 3D printing system 10 as illustrated in FIG. 2.

The hose management system 12 further includes a vertical tower 62 mounted to and extending upward from the base frame 52. A lower vertical tower end 62L may be permanently attached or, for portability reasons, demountably attached to the base frame 52. The vertical tower 62 may be supported in the upright position by a plurality of tower guy wires 64 extending from the base frame 52 and/or one or more of the outriggers 56 to an upper vertical tower end 62U opposite the lower vertical tower end 62L. A vertical pipe 66 may be rotatably coupled to the vertical tower 62 for rotation about a vertical pipe axis 68, A lower swivel bearing 70 connects a lower vertical pipe end 66L of the vertical pipe 66 to the lower vertical tower end 62L, and an upper swivel bearing 72 connects an upper vertical pipe end 66U to the upper vertical tower end 62U. The swivel bearings 70, 72 allow the vertical pipe 66 to rotate about the vertical pipe axis 68 relative to the base 50 and the vertical tower 62.

The vertical pipe 66 is hollow and serves as an initial conduit for the print medium flowing through the hose management system 12 from the print medium pump 48 to the print nozzle 18. A pump input pipe 74 may be attached proximate the lower vertical pipe end 66L for attachment of a pump hose 76. The pump input pipe 74 and the pump hose 76 place the print medium pump 48 in fluid communication with the vertical pipe 66. The pump input pipe 74 may be rigidly connected, or may be pivotally connected to move to positions that are most conducive to attachment of the pump hose 76 depending on the location of the print medium pump 48 relative to the base 50.

A boom assembly 80 may be mounted to the vertical pipe 66 proximate the upper vertical pipe end 66U. The boom assembly 80 in the illustrated embodiment includes a boom pipe 82 that is hollow and has a first boom pipe end 82A operatively connected to the upper vertical pipe end 66U to place the boom pipe 82 in fluid communication with the vertical pipe 66. The boom pipe 82 may extend approximately perpendicular to the vertical pipe axis 68, such as at an angle of 90±5°, so that the boom pipe 82 is approximately horizontal and parallel to the work surface when the base 50 is leveled by the outriggers 56. In alternative embodiments, the boom pipe 82 may extend laterally outward relative to the vertical pipe axis 68 such that boom pipe 82 is angled downward or upward relative to the work surface. For example, the boom pipe 82 may have an angle relative to the vertical pipe axis 68 within a range from 80° (i.e., 10° downward) and 135° (i.e., 45° upward). Such orientations of the boom pipe 82 may reduce the total length of pipe used in the hose management system 12 while still providing clearance from the gantry bridge 16 and the 3D object during printing. A stick support bracket 84 is connected to a second boom pipe end 82B opposite the first boom pipe end 82A for connection of a stick 86 as discussed further below.

As shown, the boom pipe 82 of the boom assembly 80 is coupled to the vertical pipe 66 by a boom support bracket 88 and an elbow joint 90. The boom support bracket 88 may be rigidly mounted to the upper vertical pipe end 66U for rotation with the vertical pipe 66. The elbow joint 90 may be disposed within the boom support bracket 88 and have a first elbow joint end 90A connected to the upper vertical pipe end 66U. The first boom pipe end 82A is connected to a second elbow joint end 90B of the elbow joint 90 to place the boom pipe 82 in fluid communication with the vertical pipe 66. The elbow joint 90 will have an angle between the elbow joint ends 90A, 90B that is necessary for the boom pipe 82 to be oriented at a specified angle relative to the vertical pipe axis 68. Further support for the boom pipe 82 may be provided by a boom guy wire 92 extending between the second boom pipe end 82B and the boom support bracket 88. With the connection provided by the boom support bracket 88, the boom pipe 82 will rotate with the vertical pipe 66 about the vertical pipe axis 68.

The stick 86 mentioned above may have a first stick end 86A connected to the boom assembly 80 at the stick support bracket 84 by a stick articulation joint 94. The stick articulation joint 94 may be any type of connection facilitating movement of the stick 86 relative to the boom pipe 82 about two or three perpendicular axes. In one embodiment, the stick articulation joint 94 may be a ball and socket joint as known in the art. In another embodiment, the stick articulation joint 94 may be formed by a first hoist swivel ring operatively connected to the stick support bracket 84, a second hoist swivel ring operatively connected to the first stick end 86A, and a connector such as a carabiner hook connecting the first hoist swivel ring and the second hoist swivel ring. The hoist swivel rings and the carabiner hook are of the type commonly known in the art and facilitate rapid connection and detachment of the stick 86 to the boom assembly 80. While allowing rotation of the stick 86 relative to the boom pipe 82 about three perpendicular axes, the hoist swivel rings and the carabiner hook arrangement allows a measure of relative linear movement to partially absorb and reduce shock loads that may occur during the printing process. Further alternative mechanisms for stick articulation joints 94 in accordance with the present disclosure providing rotation of the stick 86 about at least two perpendicular axes relative to the boom pipe 82 will be apparent to those skilled in the art as having use in hose management systems 12 in accordance with the present disclosure and are contemplated by the inventor.

The print medium flow path through the hose management system 12 may be completed by a print hose 100. The print hose 100 may have a first print hose end 100A coupled to the second boom pipe end 82B, and a second print hose end 100B coupled to the print nozzle 18. Due to the connection of the print nozzle 18, the second print hose end 100B will follow the print nozzle 18 through the printing path as the 3D object is printed. So that the remainder of the hose management system 12 also follows the print nozzle 18, the print hose 100 may be suspended from the stick 86 by suspension mechanism such as a plurality of hose support straps 102. The hose support straps 102 may be longitudinally spaced along the stick 86 to allow the print hose 100 a measure of movement relative to the stick 86. Further, in addition to the connection of the print hose 100 to the print nozzle 18, a second stick end 86B of the stick 86 may be operatively connected to the nozzle support truss 42 by straps or other connection means to pull the stick 86 and rotate the pipes 66, 82 to follow the print nozzle 18 through the print path during the printing process.

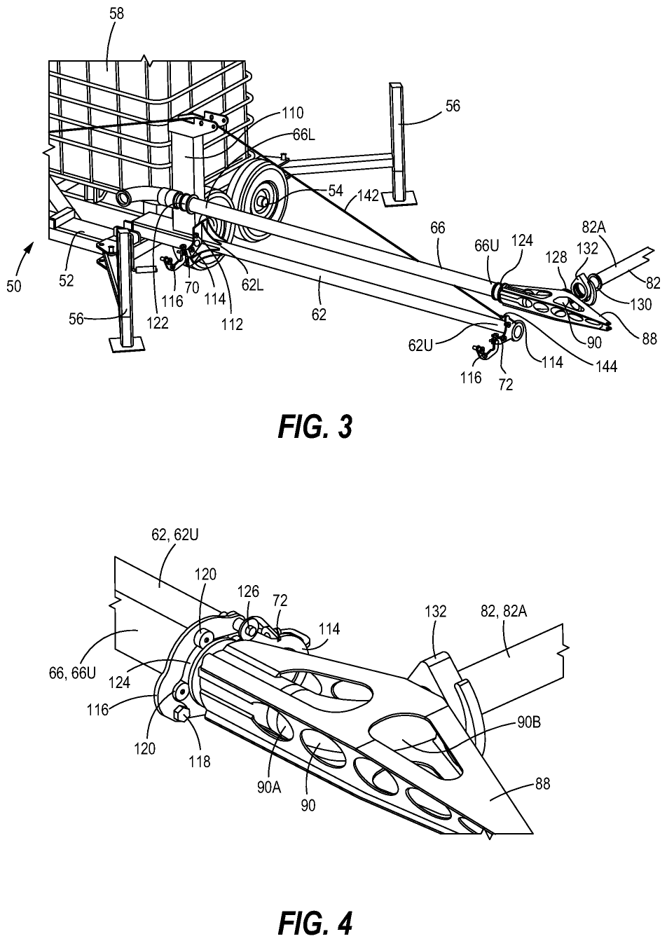

The hose management system 12 may be configured for easy assembly and disassembly to facilitate use of the hose management system 12 at different printing locations. As shown in FIG. 3, the vertical tower 62 may be detachably mounted to a pivoting tower support bracket 110 of the base frame 52. The tower support bracket 110 may pivot between an upright position shown in FIG. 2 and an installation position shown in FIG. 3. The lower vertical tower end 62L may be attached to the tower support bracket 110 by bolts 112 or other demountable attachment mechanism when the tower support bracket 110 is rotated to the installation position. Each of the swivel bearings 70, 72 may have a base bracket 114 mounted at the corresponding vertical tower end 62L, 62U, and a locking bracket 116 pivotally connected to the corresponding base bracket 114 by a pivot pin 118 to rotate between an open position shown in FIG. 3 and a closed and locked position shown in FIG. 4. The swivel bearings 70, 72 may further include a plurality of roller bearings 120 circumferentially spaced about an opening defined by the brackets 114, 116 and having rotational axes that are approximately parallel to the vertical pipe axis 68. The swivel bearings 70, 72 are positioned along the vertical tower 62 to align with a lower groove 122 and an upper groove 124, respectively, defined on the exterior surface of the vertical pipe 66. The vertical pipe 66 is installed on the vertical tower 62 by lowering the grooves 122, 124 into the base bracket 114 of the corresponding swivel bearings 70, 72 and rotating the locking brackets 116 to their locked positions with the roller bearings 120 disposed within and engaging the grooves 122, 124. The locking brackets 116 may be secured in the locked positions by corresponding locking pins 126 and engage the base brackets 114 and the locking brackets 116.

The boom support bracket 88 may be installed on the upper vertical pipe end 66U above the upper groove 124 as shown in FIGS. 3 and 4. The elbow joint 90 disposed within the boom support bracket 88 has a 90° bend between the first elbow joint end 90A and the second elbow joint end 90B. The second elbow joint end 90B may have an outwardly extending joint flange 128 corresponding to a boom flange 130 at the first boom pipe end 82A of the boom pipe 82. The boom pipe 82 may be coupled to the elbow joint 90 by a boom clamp 132 that surrounds the flanges 128, 130 and forms a seal there between to prevent leakage of print media during the printing process. The stick 86 may also be connected to the boom pipe 82 while the tower support bracket 110 is in the installation position.

With the vertical tower 62, the pipes 66, 82 and the stick 86 installed, the tower support bracket 110 may be rotated to the upright position of FIG. 2 to raise the vertical tower 62 and the vertical pipe 66 to their vertical positions. Movement to the upright position may be facilitated by providing a winch 140 (FIG. 2) mounted to the base frame 52. A winch cable 142 may extend over the tower support bracket 110 and be attached to the vertical tower 62 proximate the upper vertical tower end 62U. The winch 140 may be manually cranked or provided with a drive motor to retract the winch cable 142, rotate the tower support bracket 110 and raise the vertical tower 62, the vertical pipe 66 and the boom pipe 82. Once raised, the tower support bracket 110 may be locked in the upright position and the tower guy wires 64 attached between the base 50 and the upper vertical tower end 621.

The winch 140 may also be useful in assembly of the gantry bridge 16. The hose management system 12 may be positioned proximate the end truss 26 and centered between the side trusses 20, 22 for proximity to the gantry bridge 16 during assembly. The gantry bridge 16 may initially be assembled and pivotally attached to the X-axis carriages 38, 40 in a horizontal orientation relative to the vertical orientation shown in FIG. 1. Prior to raising the gantry bridge 16, the counterweight 58 may be filled with water for ballast and the outriggers 56 may be extended to level the hose management system 12 on the work surface. The winch cable 142 may be threaded over a pulley 144 (FIG. 2) at the upper vertical tower end 62U and attached to the center of the bridge cross truss 32. The winch 140 can then be operated to pull the gantry bridge 16 upright to the position shown in FIG. 1, at which time the bridge upright trusses 28, 30 can be secured to the X-axis carriages 38, 40 in the upright position. After the gantry bridge 16 is in position, the hose management system 12 can be repositioned to the printing position of FIG. 1.

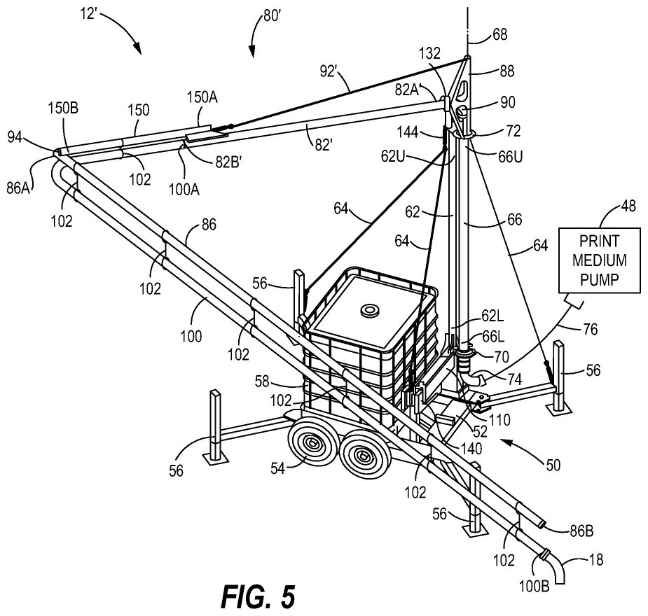

FIG. 5 illustrates an alternative embodiment of a hose management system 12′ with a variation of a boom assembly 80′. Corresponding elements of the hose management system 12′ to the hose management system 12 as illustrated and described above are identified with the same reference numerals and any differences will be noted as appropriate hereinafter. The boom assembly 80′ includes a boom pipe 82′ having a first boom pipe end 82A′ operatively coupled to the upper vertical pipe end 66U of the vertical pipe 66, and a second boom pipe end 82B′ opposite the first boom pipe end 82A′. A boom guy wire 92′ extends between the second boom pipe end 82B′ and the boom support bracket 88 to provide additional support for the boom pipe 82′. The types of flexible print hoses 100 typically used in large format 3D printing generally cannot be bent into sharp curves without collapsing and constricting flow of the print media. The print hoses 100 typically require a bend radius that is approximately 10 times the diameter of the print hose 100 to avoid collapsing. Consequently, larger print hoses 100 may necessitate a more gradual transition from the connection to the boom pipe 82′ to being supported by the stick 86. For such situations, the boom assembly 80′ may further include a boom extension 150 having a first boom extension end 150A mounted to the second boom pipe end 82B′ and extending to a second boom extension end 150B disposed remotely from the second boom pipe end 82B′. The stick articulation joint 94 as described above may connect the first stick end 86A to the second boom extension end 150B for movement of the stick 96 relative to the boom assembly 80′.

### INDUSTRIAL APPLICABILITY

The hose management systems 12, 12′ in accordance with the present disclosure provide an efficient path for delivering print media from the print medium pump 48 to the print nozzle 18 in the large format 3D printing system 10. The hose management systems 12, 12′ are set up adjacent to the gantry frame 14, and with the print hose 100 connected to the print nozzle 18 and the stick 86 connected to the nozzle support truss 42 on the same side of the gantry bridge 16 as the end truss 26. As the print nozzle 18 moves along a print path within the print area, the second print hose end 100B and the second stick end 86B follow the movement of the print nozzle 18. The stick 86 freely rotates about the stick articulation joint 94 and the vertical pipe 66 and the boom pipes 82, 82′ pivot about the vertical pipe axis 68 so that the flow paths defined by the vertical pipe 66, the boom pipes 82, 82′ and the print hose 100 follow the print nozzle 18.

By separating the print hose 100 from the gantry structure, the configuration of the hose management systems 12, 12′ facilitates coverage of the entire print area without the necessity of a hose having a length covering the combined lengths along the X, Y and Z axes of the print area. Additionally, substituting the pipes 66, 82, 82′ for hose along the flow path reduces clogging and facilitates cleaning as the print medium flows more smoothly through the pipes 66, 82, 82′ than through elastomeric hose. The remaining relatively short length print hose 100 is readily detachable from the print nozzle 18, the boom pipes 82, 82′ and the stick 86 when necessary for unclogging and cleaning.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A hose management system for a three dimensional (3D) printing system having a print medium pump and a print nozzle, the hose management system comprising:
a base;
a vertical pipe having a lower vertical pipe end and an upper vertical pipe end and operatively connected to and extending vertically upward from the base, wherein the vertical pipe is rotatable about a vertical pipe axis, and wherein a pump hose is operatively coupled to the lower vertical pipe end to place the vertical pipe in fluid communication with the print medium pump;
a boom pipe having a first boom pipe end operatively connected to the upper vertical pipe end and extending laterally outward relative to the vertical pipe axis from the first boom pipe end to a second boom pipe end, wherein the boom pipe rotates with the vertical pipe about the vertical pipe axis;
a stick having a first stick end operatively connected to the second boom pipe end for rotation relative to the boom pipe about at least two perpendicular axes; and
a print hose having a first print hose end connected to the second boom pipe end and a second print hose end connected to the print nozzle to place the print nozzle in fluid communication with the print medium pump, wherein the print hose is operatively connected to the stick such that the vertical pipe, the boom pipe, the stick and the print hose follow movement of the print nozzle by the 3D printing system to print a 3D object.

2. The hose management system of claim 1, comprising a counterweight mounted on the base.

3. The hose management system of claim 1, wherein the print medium pump is mounted on the base as a counterweight.

4. The hose management system of claim 1, comprising a vertical tower extending upward from the base, wherein the vertical pipe is pivotally connected to the vertical tower for rotation about the vertical pipe axis.

5. The hose management system of claim 4, comprising:
a lower swivel bearing connecting the lower vertical pipe end to the vertical tower; and
an upper swivel bearing connecting the upper vertical pipe end to the vertical tower.

6. The hose management system of claim 4, comprising an elbow joint connecting the first boom pipe end to the upper vertical pipe end.

7. The hose management system of claim 6, comprising a boom support bracket mounted on the upper vertical pipe end and supporting the elbow joint.

8. The hose management system of claim 1, comprising a boom assembly comprising:
the boom pipe; and
a boom extension mounted to the second boom pipe end, wherein the stick is operatively connected to the boom extension at a stick articulation joint.

9. The hose management system of claim 1, comprising a stick articulation joint comprising:
a first hoist swivel ring operatively connected to the second boom pipe end;
a second hoist swivel ring operatively connected to the first stick end; and
a carabiner hook connecting the first hoist swivel ring to the second hoist swivel ring.

10. The hose management system of claim 1, comprising a plurality of hose support straps connected to and longitudinally spaced along the stick and suspending the print hose from the stick.

11. A hose management system for a three dimensional (3D) printing system having a print medium pump and a print nozzle, the hose management system comprising:
a base;
a vertical tower extending upward from the base;
a vertical pipe pivotally connected to the vertical tower for rotation about a vertical pipe axis and having a lower vertical pipe end and an upper vertical pipe end, and wherein a pump hose is operatively coupled to the lower vertical pipe end to place the vertical pipe in fluid communication with the print medium pump;
a boom assembly operatively connected to the upper vertical pipe end and extending laterally outward relative to the vertical pipe axis from the upper vertical pipe end, wherein the boom assembly rotates with the vertical pipe about the vertical pipe axis;
a stick having a first stick end operatively connected to the boom assembly for rotation relative to the boom assembly about at least two perpendicular axes; and
a print hose having a first print hose end connected to the boom assembly and a second print hose end connected to the print nozzle to place the print nozzle in fluid communication with the print medium pump, wherein the print hose is operatively connected to the stick such that the vertical pipe, the boom assembly, the stick and the print hose follow movement of the print nozzle by the 3D printing system to print a 3D object.

12. The hose management system of claim 11, comprising:
a lower swivel bearing connecting the lower vertical pipe end to the vertical tower; and
an upper swivel bearing connecting the upper vertical pipe end to the vertical tower.

13. The hose management system of claim 11, comprising an elbow joint connecting the boom assembly to the upper vertical pipe end.

14. The hose management system of claim 13, comprising a boom support bracket mounted on the upper vertical pipe end and supporting the elbow Joint.

15. The hose management system of claim 11, wherein the boom assembly comprises:
a boom pipe operatively connected to the upper vertical pipe end; and
a boom extension mounted to the boom pipe opposite the vertical pipe, wherein the stick is operatively connected to the boom extension at a stick articulation joint.

16. The hose management system of claim 11, wherein the boom assembly comprises:
a boom pipe operatively connected to the upper vertical pipe end; and
a stick support bracket mounted to the boom pipe opposite the vertical pipe, wherein the stick is operatively connected to the stick support bracket at a stick articulation joint.

17. The hose management system of claim 11, comprising a stick articulation joint comprising:
a first hoist swivel ring operatively connected to the boom assembly opposite the vertical pipe;
a second hoist swivel ring operatively connected to the first stick end; and
a carabiner hook connecting the first hoist swivel ring to the second hoist swivel ring.

18. A hose management system for a three dimensional (3D) printing system having a print medium pump and a print nozzle, the hose management system comprising:
a base;
a vertical tower extending upward from the base;
a vertical pipe having a lower vertical pipe end, an upper vertical pipe end and a vertical pipe axis, and wherein a pump hose is operatively coupled to the lower vertical pipe end to place the vertical pipe in fluid communication with the print medium pump;
a lower swivel bearing connecting the lower vertical pipe end to the vertical tower;
an upper swivel bearing connecting the upper vertical pipe end to the vertical tower, wherein the lower swivel bearing and the upper swivel bearing pivotally connect the vertical pipe to the vertical tower for rotation about the vertical pipe axis;
a boom pipe operatively connected to the upper vertical pipe end and extending laterally outward relative to the vertical pipe axis from the upper vertical pipe end, wherein the boom pipe rotates with the vertical pipe about the vertical pipe axis;
a boom extension mounted to the boom pipe opposite the vertical pipe;
a stick having a first stick end and a second stick end;
a stick articulation joint operatively connecting the first stick end to the boom extension for rotation of the stick relative to the boom extension about at least two perpendicular axes; and
a print hose having a first print hose end connected to the boom pipe and a second print hose end connected to the print nozzle to place the print nozzle in fluid communication with the print medium pump, wherein the print hose is operatively connected to the stick such that the vertical pipe, the boom pipe, the stick and the print hose follow movement of the print nozzle by the 3D printing system to print a 3D object.

19. The hose management system of claim 18, wherein the stick articulation joint comprises:
a first hoist swivel ring operatively connected to the boom extension;
a second hoist swivel ring operatively connected to the first stick end; and
a carabiner hook connecting the first hoist swivel ring to the second hoist swivel ring.

20. The hose management system of claim 18, comprising a plurality of hose support straps connected to and longitudinally spaced along the stick and suspending the print hose from the stick.
